(19) United States
(12) Patent Application Publication
(10) Pub. No.: US 2008/0104203 A1
(43) Pub. Date: May 1, 2008

(54) Viewing Digital Information Over a Network

(75) Inventors: Oliver H. Foehr, Mercer Island, WA (US); Joseph D. Ternasky, Mountain View, CA (US); Hubert Van Hoof, Seattle, WA (US); Viadimir Sadovsky, Bellevue, WA (US); Michael D. Stokes, Eagle, ID (US); Andrey Shur, Redmond, WA (US); Jerry J. Dunietz, Seattle, WA (US); Sarjana Sheth, Redmond, WA (US); Bruce Allan MacKenzie, Sammamish, WA (US); Young Gah Kim, Bothell, WA (US); Alexei Vopilov, Redmond, WA (US); David Ornstein, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/555,154

(22) Filed: Oct. 31, 2006

(51) Int. Cl. G06F 15/16

(52) U.S. Cl. 709/219

(57) ABSTRACT

Methods and systems described herein provide a name-based access mechanism that can enable name-based requests to be generated and sent to a server to retrieve correspondingly named parts of a document. In at least some embodiments, a resource designator associated with the document is wrapped or encapsulated using a special scheme which appends a name associated with the desired document part to the encapsulated resource designator Once a server receives the encapsulated resource designator, the server can locate the named document part and stream or otherwise provide the document part to the requesting client device.

### BACKGROUND

Often times in a server environment, in order to access a portion of a particular document, the server will need to stream the entire document to a client device. Once the entire document or at least a very large portion of the document is at the client device, the client device or, more accurately, software executing on the client device can begin to process the document to provide access to the desired portion of the document. If a document is small, this solution does not carry with it inefficiencies that rise to a level of serious concern. However, consider the case in which the document is quite large. In this case it becomes inefficient to stream or otherwise provide the entire document to the client device when only a portion of the document is desired to be accessed.

### SUMMARY

Methods and systems described herein provide a name-based access mechanism that can enable name-based requests to be generated and sent to a server to retrieve correspondingly named parts of a document. In at least some embodiments, a resource designator associated with the document is wrapped or encapsulated using a special scheme which appends a name associated with the desired document part to the encapsulated resource designator. Once a server receives the encapsulated resource designator, the server can locate the named document part and stream or otherwise provide the document part to the requesting client device.

### BRIEF DESCRIPTION OF THE DRAWINGS

FIG. 1 illustrates an exemplary package in accordance with one embodiment.

FIG. 2 illustrates an exemplary writer, reader and package in accordance with one embodiment.

FIG. 3 illustrates an exemplary environment that depicts a package having a plurality of related parts in accordance with one embodiment.

FIG. 4 illustrates an exemplary system in accordance with one embodiment.

FIG. 5 is a flow diagram that describes steps in a method in accordance with one embodiment.

### DETAILED DESCRIPTION

Overview

Methods and systems described herein provide a name-based access mechanism that can enable name-based requests to be generated and sent to a server to retrieve correspondingly named parts of a document. In at least some embodiments, a resource designator associated with the document is wrapped or encapsulated using a special scheme which appends a name associated with the desired document part to the encapsulated resource designator. Once a server receives the encapsulated resource designator, the server can locate the named document part and stream or otherwise provide the document part to the requesting client device.

Various described embodiments make use of a modular content framework and document format. The framework and format define a set of building blocks for composing, packaging, distributing, and rendering document-centered content. These building blocks define a platform-independent framework for document formats that enable software and hardware systems to generate, exchange, and display documents reliably and consistently.

In the discussion that follows, a primary section entitled “Exemplary Framework” provides a high level overview of an exemplary framework for representing documents that can be utilized by the inventive embodiments. It should be understood that this framework constitutes but one exemplary framework that can be leveraged by the inventive embodiments. As such, other frameworks can be utilized without departing from the spirit and scope of the claimed subject matter. Following this section, another primary section entitled “Exemplary Embodiments” is provided and describes various inventive embodiments.

Exemplary Framework

The exemplary framework discussed below presents a packaging model in which a document is represented by various parts and relationships between the parts. This framework and format are described in more detail in U.S. patent application Ser. No. 10/837,040, filed on Apr. 30, 2004.

The Package Model

This section describes an exemplary package model and includes sub-headings that describe packages and parts, drivers, relationships, package relationships and the start part.

Packages and Parts

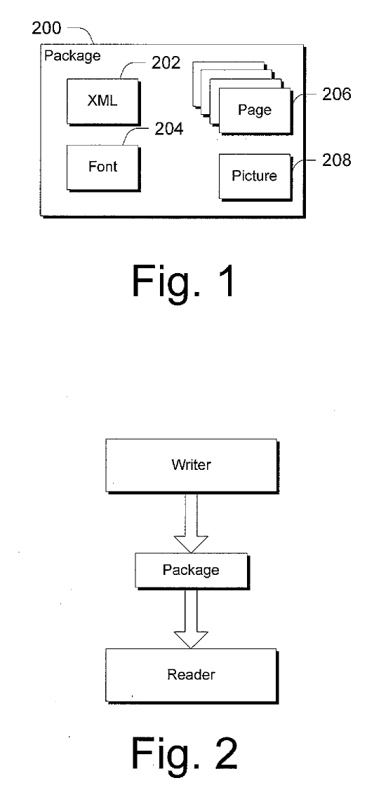

In the illustrated and described model, content is held within a package. A package is a logical entity that holds a collection of related parts. The package's purpose is to gather up all of the pieces of a document (or other types of content) into one object that is easy for programmers and end-users to work with. For example, consider FIG. 1 which illustrates an exemplary package 200 holding a document comprising a number of parts including an XML markup part 202 representing the document, a font part 204 describing a font that is used in the document, a number of page parts 206 describing pages of the document, and a picture part representing a picture or image within the document. The XML 11 markup part 202 that represents a document is advantageous in that it can permit easy searchability and referencing without requiring the entire content of a package to be parsed.

A “reader”, as that term is used in this document, refers to an entity that reads modular content format-based files or packages. A “writer”, as that term is used in this document, refers to an entity that writes modular content format-based files or packages.

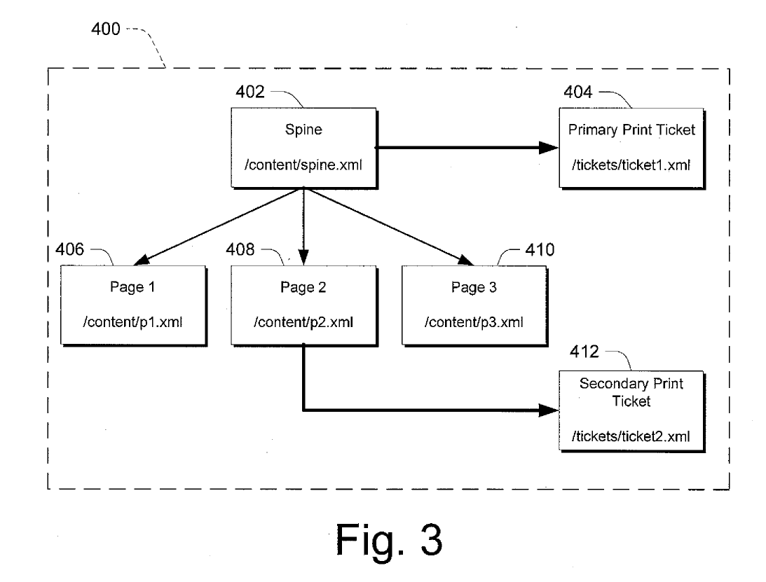

As an example, consider FIG. 2, which shows a writer that produces a package and a reader that reads a package. Typically, the writer and reader will be embodied as software. In at least one embodiment) much of the processing overhead and complexities associated with creating and formatting packages is placed on the writer. This, in turn, removes much of the processing complexity and overhead from readers which, as will be appreciated by the skilled artisan, is a departure from many current models.

In accordance with at least one embodiment, a single package contains one or more representations of the content held in the package. Often a package will be a single file, referred to in this application as a “container”. This gives end-users, for example, a convenient way to distribute their documents with all of the component pieces of the document (images, fonts, data, etc.). While packages often correspond directly to a single file, this is not necessarily always so, A package is a logical entity that may be represented physically in a variety of ways (e.g., without limitation, in a single file, a collection of loose files, in a database, ephemerally in transit over a network connection, etc.). Thus, containers hold packages, but not all packages are stored in containers.

An abstract model describes packages independently of any physical storage mechanism. For example, the abstract model does not refer to “files”, “streams”, or other physical terms related to the physical world in which the package is located. The abstract model allows users to create drivers for various physical formats, communication protocols, and the like. By analogy, when an application wants to print an image, it uses an abstraction of a printer (presented by the driver that understands the specific kind of printer). Thus, the application is not required to know about the specific printing device or how to communicate with the printing device.

A container provides many benefits over what might otherwise be a collection of loose, disconnected files. For example, similar components may be aggregated and content may be indexed and compressed. In addition, relationships between components may be identified and rights management, digital signatures, encryption and metadata may be applied to components. Of course containers can be used for and can embody other features which are not specifically enumerated above.

Common Part Properties

In the illustrated and described embodiment, a part comprises common properties (e.g., a name) and a stream of bytes. This is analogous to a file in a file system or a resource on an HTTP server. In addition to its content, each part has some common part properties. These include a name—which is the name of the part, and a content type—which is the type of content stored in the part. Parts may also have one or more associated relationships.

Part names are used whenever it is necessary to refer in some way to a part. In the embodiments described below, part names are used to build requests for portions of a document—thus, effectively providing random access into a document over a network such as the Internet.

In the illustrated and described embodiment, names are organized into a hierarchy, similar to paths on a file system or paths in URIs. Below are examples of part names:

/document.xml
/tickets/ticket.xml
/images/march/summer.jpeg
/pages/page4.xml

As seen above, in this embodiment, part names have the following characteristics:
Part names are similar to file names in a traditional file system.
Part names begin with a forward slash (‘/’).
Like paths in a file-system or paths in a URI, part names can be organized into a hierarchy by a set of directory-like names (tickets, images/march and pages in the above examples).
This hierarchy is composed of segments delineated by slashes.
The last segment of the name is similar to a filename a traditional file-system.

It is important to note that the rules for naming parts, especially the valid characters that can be used for part names, can be specific to the framework described in this document. These part name rules are based on internet-standard URI naming rules. In accordance with this embodiment, the grammar used for specifying part names in this embodiment exactly matches abs_path syntax defined in Sections 3.3 (Path Component) and 5 (Relative URI References) of RFC2396, (Uniform Resource Identifiers (URI: Generic Syntax) specification.

The segments of the names of all parts in a package form a tree. This is analogous to what happens in file systems, in which all of the non-leaf nodes in the tree are folders and the leaf nodes are the actual files containing content. These folder-like nodes (i.e., non-leaf nodes) in the name tree serve a similar function of organizing the parts in the package. It is important to remember, however, that these “folders” exist only as a concept in the naming hierarchy—they have no other manifestation in the persistence format.

In the illustrated and described embodiment, every part has a content type which identifies what type of content is stored in a part. Examples of content types include:

image/jpeg
text/xml
text/plain; charset=“us-ascii”

Content types are used in the illustrated framework as defined in RFC2045 (Multipurpose Internet Mail Extensions; (MIME)). Specifically, each content type includes a media type (e.g., text), a subtype (e.g., plain) and an optional set of parameters in key=value form (e.g., charset=“us-ascii”); multiple parameters are separated by semicolons.

Part Addressing

Often parts will contain references to other parts. As a simple example, imagine a container with two parts: a markup file and an image. The markup file will want to hold a reference to the image so that when the markup file is processed, the associated image can be identified and located. Designers of content types and XML schemas may use URIs to represent these references. To make this possible, a mapping between the world of part names and world of URIs defined.

In order to allow the use of URIs in a package, a special URI interpretation rule is used when evaluating URIs in package-based content: the package itself should be treated as the “authority” for URI references and the path component of the URI is used to navigate the part name hierarchy in the package.

For example, given a package URI of http://www.example.com/foo/something.package, a reference to /abc/bar.xml is interpreted to mean the part called /abc/bar.xml, not the URI http://www.example.com/abc/bar.xml.

Relative URIs should be used when it is necessary to have a reference from one part to another in a container. Using relative references allows the contents of the container to be moved together into a different container (or into the container from, for example, the file system) without modifying the cross-part references.

Relative references from a part are interpreted relative to the “base URI” of the part containing the reference. By default, the base URI of a part is the part's name.

Consider a container which includes parts with the following names:

/markup/page.xml
/images/picture.jpeg
/images/other_picture.jpeg

If the “/markup/page.xml” part contains a URI reference to “../images/picture.jpeg”, then this reference must be interpreted as referring to the part name “/images/picture.jpeg”, according to the rules above.

Some content types provide a way to override the default base URI by specifying a different base in the content. In the presence of one of these overrides, the explicitly specified base URI should be used instead of the default.

Sometimes it is useful to “address” a portion or specific point in a part. In the URI world, a fragment identifier is used [see, e.g. RFC2396]. In a container, the mechanism works the same way. Specifically, the fragment is a string that contains additional information that is understood in the context of the content type of the addressed part. For example, in a video file a fragment might identify a frame, in an XML file it might identify a portion of the XML file via an xpath.

A fragment identifier is used in conjunction with a UR that addresses a part to identify fragments of the addressed part. The fragment identifier is optional and is separated from the URI by a crosshatch (“#”) character. As such, it is not part of a URI, but is often used in conjunction with a URI.

Relationships

Parts in a package may contain references to other parts in that package. In general, however, these references are represented inside the referring part in ways that are specific to the content type of the part; that is, in arbitrary markup or an application-specific encoding. This effectively hides the internal linkages between parts from readers that don't understand the content types of the parts containing such references.

Even for common content types, a reader would need to parse all of the content in a part to discover and resolve the references to other parts. For example, when implementing a print system that prints documents one page at a time, it may be desirable to identify pictures and fonts contained in the particular 19 page. Existing systems must parse all information for each page, which can be time consuming, and must understand the language of each page, which may not be the situation with certain devices or readers (e.g., ones that are performing intermediate processing on the document as it passes through a pipeline of processors on the way to a device). Instead, the systems and methods described herein use relationships to identify relationships between parts and to describe the nature of those relationships. The relationship language is simple and defined once so that readers can understand relationships without requiring knowledge of multiple different languages. In one embodiment, the relationships are represented in XML as individual parts. Each part has an associated relationship part that contains the relationships for which the part is a source.

For example, a spreadsheet application uses this format and stores different spreadsheets as parts. An application that knows nothing about the spreadsheet language can still discover various relationships associated with the spreadsheets. For example, the application can discover images in the spreadsheets and metadata associated with the spreadsheets. An example relationship schema is provided below:

```
<?xml version=“1.0” encoding=“UTF-8” standalone=“no”?>
<xsd:schema xmlns=“http://schemas.openxmlformats.org/package/2006/relationships”
xmlns:xsd=“http://www.w3.org/2001/XMLSchema”
targetNamespace=“http://schemas.openxmlformats.org/package/2006/relationships”
elementFormDefault=“qualified” attributeFormDefault=“unqualified”
blockDefault=“#all”>
  <xsd:element name=“Relationships” type=“CT_Relationships” />
  <xsd:element name=“Relationship” type=“CT_Relationship” />
  <xsd:complexType name=“CT_Relationships”>
    <xsd:sequence>
      <xsd:element ref=“Relationship” minOccurs=“0” maxOccurs=“unbounded” />
    </xsd:sequence>
  </xsd:complexType>
  <xsd:complexType name=“CT_Relationship”>
    <xsd:simpleContent>
      <xsd:extension base=“xsd:string”>
        <xsd:attribute name=“TargetMode” type=“ST_TargetMode” use=“optional” />
        <xsd:attribute name=“Target” type=“xsd:anyURI” use=“required” />
        <xsd:attribute name=“Type” type=“xsd:anyURI” use=“required” />
        <xsd:attribure name=“Id” type=“xsd:ID” use=“required” />
      </xsd:extension>
    </xsd:simpleContent>
  </xsd:complexType>
  <xsd:simpleType name=“ST_TargetMode”>
    <xsd:restriction base=“xsd:string”>
      <xsd:enumeration value=“External” />
      <xsd:enumeration value=“Internal” />
    </xsd:restriction>
  </xsd:simpleType>
</xsd:schema>
```

This schema defines two XML elements, one called “relationships” and one called “relationship.” This “relationship” element is used to describe a single relationship as described herein and has the attributes described above which include the 1 “target” attribute that indicates the part to which the source part is related, and the “type” attribute that indicates the type or nature of the relationship. The “relationships” element is defined to allow it to hold zero or more “relationship” elements and serves simply to collect these “relationship” elements together in a unit.

The systems and methods described herein introduce a higher-level mechanism to solve these problems called “relationships”. Relationships provide an additional Way to represent the kind of connection between a source part and a target part in a package. Relationships make the connections between parts directly “discoverable” without looking at the content in the parts, so they are independent of content-specific schema and faster to resolve. Additionally, these relationships are protocol independent. A variety of different relationships may be associated with a particular part.

Relationships provide a second important function: allowing parts to be related without modifying them. Sometimes this information serves as a form of “annotation” where the content type of the “annotated” part does not define a way to attach the given information. Potential examples include attached descriptive metadata, print tickets and true annotations. Finally, some scenarios require information to be attached to an existing part specifically without modifying that part—for example, when the part is encrypted and can not be decrypted or when the part is digitally signed and changing it would invalidate the signature. In another example, a user may want to attach an annotation to a JPEG image file. The JPEG image format does not currently provide support for identifying annotations. Changing the JPEG format to accommodate this user's desire is not practical. However, the systems and methods discussed herein allow the user to provide an annotation to a JPEG file without modifying the JPEG image format.

In one embodiment, relationships are represented using XML in relationship parts. Each part in the container that is the source of one or more relationships has an associated relationship part. This relationship part holds (expressed in XML using the content type application/PLACEHOLDER) the list of relationships for that source part.

FIG. 3 below shows an environment 400 in which a “spine” part 402 binds together three pages 406, 408 and 410. The set of pages bound together by the spine has an associated “print ticket” 404. Additionally, page 2 has its own print ticket 412. The connections from the spine part 402 to its print ticket 404 and from page 2 to its print ticket 412 are represented using relationships. In the arrangement of FIG. 3, the spine part 402 would have an associated relationship part which contained a relationship that connects the spine to ticket1, as shown in is the example below.

<?xml version=“1.0” encoding=“utf-8”?>
<Relationships
xmlns=“http://schemas.openxmlformats.org/package/2006/relationships”>
<Relationship Target=“/Documents/1/Metadata/Page1_PT.xml” Id=“R3”
Type=“http://schemas.microsoft.com/xps/2005/06/printticket”/>
</Relationships>

Relationships are represented using <Relationship> elements nested in a single <Relationships> element. See the example schema above, and related discussion, for example relationships.

The relationships part is not permitted to participate in other relationships. However, it is a first class part in all other senses (e.g., it is URI addressable, it can be opened, read, deleted, etc.). Relationships do not typically point at things outside the package. URIs used to identify relationship targets do not generally include a URI scheme.

A part and its associated relationship part are connected by a naming convention. In this example, the relationship part for the spine would be stored in /content/_rels/spine.xml.rels and the relationships for page 2 would be stored in /content/_rels/p2.xml.rels. Note two special naming conventions being used here. First, the relationship part for some (other) part in a given “folder” in the name hierarchy is stored in a “sub-folder” called _rels (to identify relationships). Second, the name of this relationship-holding part is formed by appending the .rels extension to the name of the original part. In particular embodiments, relationship parts are of the content type application/xml+relationshipsPLACEHOLDER.

A relationship represents a directed connection between two parts. Because of the way that the relationship is being represented, it is efficient to traverse relationships from their source parts (since it is trivial to find the relationships part for any given part).

Package Relationships

“Package Relationships” are used to find well-known parts in a package. This method avoids relying on naming conventions for finding parts in a package, and ensures that there will not be collisions between identical part names in different payloads.

Package relationships are special relationships whose target is a part, but whose source is not: the source is the package as a whole. To have a “well-known” part is really to have a “well-known” relationship name that helps you find that part. This works because there is a well-defined mechanism to allow relationships to be named by non-coordinating parties, while certain embodiments contain no such mechanism for part name—those embodiments are limited to a set of guidelines. The package relationships are found in the package relationships part (also referred to as the “root relationship part”), and is named using the standard naming conventions for relationship parts. Thus: it's named “_rels/.rels”

Relationships in this package relationships part are useful in finding well-known parts. Further, by finding the individual parts of a particular package or document, a mechanism is provided for conducting name-based document part requests, as will be described in detail below.

Having now described an exemplary framework and format, consider the discussion below which describes an exemplary way to access individual parts of a document over a network, such as the Internet, without requiring a server to stream the entire document to the requesting device.

### Exemplary Embodiments

In the embodiments described below, a name-based access mechanism is provided and enables name-based requests to be generated and sent to a server to retrieve correspondingly named parts of a document. In at least some embodiments, a resource designator associated with the document is wrapped or encapsulated using a special scheme which appends a name associated with the desired document part to the encapsulated resource designator. Once a server receives the encapsulated resource designator, the server can locate the named document part and stream or otherwise provide the document part to the requesting client device.

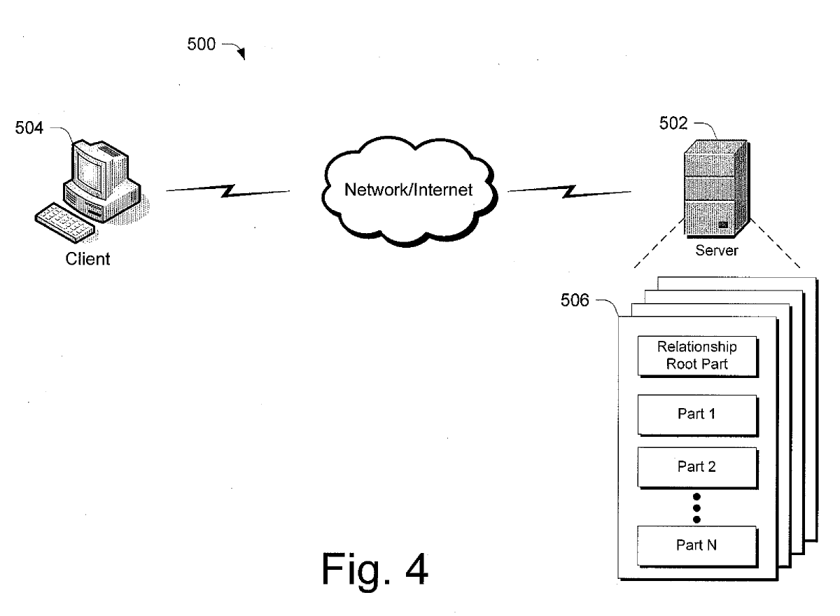

As an example, consider FIG. 4 which illustrates an exemplary system in accordance with one embodiment, generally at 500. Here, system 500 includes one or more servers 502 and one or more consuming clients 504. In this example, the methodology described below can be implemented in form of software that resides on some type of computer-readable media (e.g. RAM, ROM, flash, hard disk and the like) at the client and/or the server.

In this example, server 502 includes one or more documents 506 conforming generally to the description just above. The client 504 is able to generate name-based requests for document parts and, using a network such as the Internet, convey those requests to server 502.

In this example, individual documents maintained by the server include a relationship root part and one or more other parts, as graphically indicated. Recall from the description above that a package relationship part or relationship root part references the other parts or discoverable payloads of the package and hence, can be used to ascertain the individual parts or payloads of a particular package or container.

In the illustrated and described embodiment, when a client wishes to request a part of a document, the client builds a request URJ that includes or otherwise references the container location and the relationship root part of the particular document. It does this, in this example, using a special wrapping or encapsulator that can be recognized by the server. The URI for a particular document can be defined using any suitable protocol such as http:, ftp:, and the like and can include any arbitrary URI. For example, consider the URI provided just below that references a document at server 502:
http://www.microsoft.com/xps/sample.opc

In accordance with one embodiment, software executing on the client takes this URI which references a document named “sample.opc” and uses it to request the relationship root part (or the starting part for consumption) of that document. The relationship root part can then be used in a recursive process that builds a name-based request. As an example, consider the URI just below:
pack://http%3c,,www.microsoft.com,xps,sample.opc/_rels/.rel

Here, notice that the URI of the document is similar in the sense that it includes the document URI, some special characters, and the “/” characters have been replaced by “,”. Notice further that prepended to the modified document URI is a reference to a special protocol handler-here referred to as “pack”. The reference to the pack protocol handler indicates to the server that the URI represents a request for a specific part of a referenced document-here, the relationship root part.

When the server receives the request for the document's relationship root part, it accesses the document's package and returns the relationship root part to the client. In the illustrated and described embodiment, the relationship root part is returned as XML that contains a description of the discoverable payloads. In the FIG. 4 example, the returned XML would describe document parts 1-N.

Now, having discovered the individual parts of the document as described by the relationship root part, the client can now request individual parts of that particular document. In the illustrated and described embodiment, this is done utilizing a name-based approach that requests the document parts by name.

In the particular example, requests for individual discrete parts of a document are structured using a reference to a special protocol handler that is recognized by the server. As an example, consider the wrapped or encapsulated URI just below:
pack://http%3c,,www.microsoft.com,xps,sample.opc/part3

Here, notice that the URI of the document is similar in the sense that it includes the document URI, again with the special characters and the “/” characters replaced by “,”. Notice also that the modified document URI has appended to it the name of the specific part of the document that is being requested. Specifically, in this example, the requested part is “part3” of the document. Notice further that prepended to the modified document URI is the pack protocol handler. The reference to the pack protocol handler indicates to the server that the URI represents a request for a specific part of a referenced document.

Knowing this, the server can handle the request with a special handler that locates the document that corresponds to the requested part, unpacks the document package and sends the requested document part to the requesting client.

By using a name-based approach, inefficiencies and uncertainties associated with other approaches, such as byte range requests, can be mitigated. For example, byte range requests can clash with the notion of compression and encryption. Specifically, assume that the server can authenticate the client, but still does not trust the client with a decryption key associated with a document or document portion, and instead wishes to perform the decryption of the content on the server and transfer the decrypted content via a secure connection. In this instance, because the document is compressed, the client may not necessarily know the relevant uncompressed byte range to request. And, since the server does not trust the client with the key, it would be pointless to transfer the encrypted data to the client.

Alternately, using the name-based request, the matter of dealing with encryption and compression is relatively trivial. Specifically, the client can request the specific part of the document by name and the server can uncompress the document part and send it to the client. Hence, the server can maintain keys and it makes no difference whether the server trusts the client with the keys or not, because the client only ever sees the decrypted data of the portion of the document it is authenticated to see.

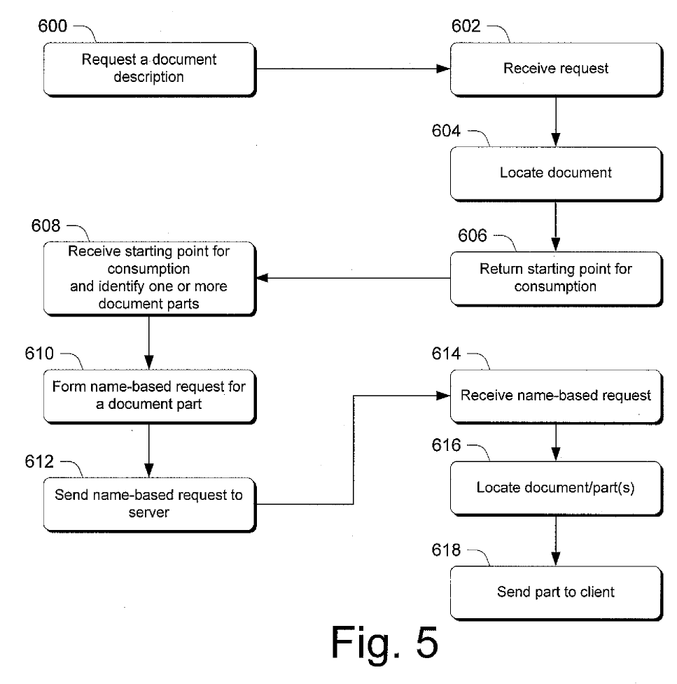

FIG. 5 is a flow diagram that describes steps in a method in accordance with one embodiment. The steps can be implemented in any suitable software, hardware, firmware or combination thereof. In at least some embodiments, the method can be implemented in software that executes on the client and the server. That is, in the description below and, as designated in the figure, some of the depicted steps can be implemented by an appropriately configured client device and an appropriately configured server device.

Step 600 requests, from a server, a description of a document that is to serve as a basis from which a request for a document part is to be formed. But one example of how this can be done is given above. Specifically, a modified document URI can be utilized to request the starting point for consumption of a specific document which, in the example above, comprises a relationship root part.

Step 602 receives, with a server, the request and step 604 locates the document of interest. Step 606 returns to the client a starting point for consumption of the document, e.g. a package relationship part. Step 608 receives the starting point for consumption and identifies one or more document parts of interest. Step 610 then forms a named-based request for a part of the document and step 612 sends the name-based request to the server. One example of a name-based request is provided above. There, a modified document URI is wrapped with a reference to a special protocol handler and is appended with the name of the requested part.

Once the server receives the name-based request (step 614), it can locate the document of interest and the corresponding part (step 616). Step 618 then sends the requested document part to the requesting client.

In at least some embodiments, using the techniques described above, document parts can be delivered in one transaction by leveraging the relationship structure of a document package. Specifically, the “pack:” scheme grammar can be expanded to be able to identify a part within a remote package not only by the part's names but also by a chain of relationships targeting this part from the root of the package.

Exemplary Extensions

Consider now that when the client makes its request for a particular document part (or at another time), it can convey to the server information that the server can utilize to make document part delivery more efficient.

Assume that a particular document is associated with a library of images and that all of the images in the package are at a very high quality. Assume also that the client and the server, through some protocol, establish some desired image qualities. For example, if the requesting client is a handheld device, perhaps the client only wants images at a lower quality. Once the server knows this, the server can then down sample the image(s) and send much less data than it would otherwise send.

Further, consider that in the structure described above, all of the parts that are utilized to render a document are contained in or otherwise referenced by the document package. If a particular requested document utilizes a specific font, and if that specific font is already locally available, then there is no need for the server to send the font data to the client. Rather, the client can replace any remote font references to local references. Hence, the need to download a particular font is eliminated.

Alternately or additionally, the URI scheme described above can be used to convey to the server the client's intentions with respect to a document part request. This can then allow the server to take steps to ensure that the client's intentions are preserved. For example, the URI that is sent to the server can include information that conveys to the server that the client wishes to have exclusive write access to a particular document part. Knowing this, the server can lock down the document part so that only the requesting client can have write access. All other requests from other clients might then return a read only version of the document part.

These extensions can be achieved by taking advantage of the URI query notation, e.g. appending “?+parameter” to the end of a URI.

### CONCLUSION

In the embodiments described above, a name-based access mechanism is provided and enables name-based requests to be generated and sent to a server to retrieve correspondingly named parts of a document. In at least some embodiments, a resource designator associated with the document is wrapped or encapsulated using a special scheme which appends a name associated with the desired document part to the encapsulated resource designator. Once a server receives the encapsulated resource designator, the server can locate the named document part and stream or otherwise provide the document part to the requesting client device.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
generating a name-based request for a correspondingly named part of a document, wherein the name-based request requests less than an entirety of the document; and
sending, via a network, the name-based request to a server.

2. The method of claim 1, wherein the network comprises the Internet.

3. The method of claim 1, wherein the act of generating comprises appending the part name to a document's resource designator.

4. The method of claim 1, wherein the act of generating comprises including, as part of the name-based request, a reference to a protocol handler for handling the requests, wherein the protocol handler can wrap an arbitrary source URI for the document.

5. The method of claim 1, wherein the act of generating comprises appending the part name to a document's resource designator and including, as part of the name-based request, a reference to a protocol handler for handling the requests, wherein the protocol handler can wrap an arbitrary source URI for the document and can include an appended relative URI for the correspondingly named part.

6. The method of claim 1 further comprising receiving, from the server, the requested document part.

7. A computer-implemented method comprising:
building a packed request URI that includes a reference to a document container and to a relationship root part within the named document container;
sending the request URI to a server;
receiving, from the server, the relationship root part for the document; and
using the relationship root part to build a name-based request for one or more individual parts of the document, wherein the relationship root part can be used in a recursive process that builds the name-based request.

8. The method of claim 7, wherein the act of using comprises using an encapsulator to encapsulate a modified document URI, wherein the encapsulator is recognizable by a server to which the name-based request is to be transmitted.

9. The method of claim 8, wherein the encapsulator references a protocol handler.

10. The method of claim 8, wherein the name-based request comprises a document part name appended to the modified document URI.

11. The method of claim 7 further comprising sending the name-based request to the server and, responsive thereto, receiving one or more individual parts of the document.

12. The method of claim 11, wherein the request URI and name-based request are sent to the server via the Internet.

13. The method of claim 7, wherein the name-based request requests less than an entirety of the document.

14. A computer-implemented method comprising:
receiving, from a client device, a request for a starting point for consumption of a document, wherein the starting point describes individual parts of an associated document;
returning the starting point to the client device;
responsive to said act of returning, receiving a name-based request for one or more parts of the document; and
sending one or more document parts to the client device.

15. The method of claim 14, wherein the request for a starting point comprises a request for the document's relationship root part.

16. The method of claim 15, wherein the relationship root part is defined in XML.

17. The method of claim 14, wherein the name-based request comprises a modified document URI.

18. The method of claim 14, wherein the name-based request includes a reference to a protocol handler.

19. The method of claim 14, wherein the name-based request comprises a modified document URI and a reference to a protocol handler that is recognized by a server.

20. The method of claim 14, wherein the acts of receiving the request, returning the document, receiving a name-based request and sending one or more document parts are performed via the Internet.
